(19) United States
(12) Patent Application Publication
(10) Pub. No.: US 2025/0296214 A1
(43) Pub. Date: Sep. 25, 2025

(54) Smart HammerDriver: A Hand Tool Combining Impact, Measurement, and Power-Drive Capabilities

(71) Applicant: MUHAMMAD JASEEM, Houston, TX (US)

(72) Inventor: MUHAMMAD JASEEM, Houston, TX (US)

(21) Appl. No.: 19/180,161

(22) Filed: Apr. 16, 2025

(51) Int. Cl. B25D 1/00; B25G 1/01; B25G 1/10

(52) U.S. Cl. CPC B25D 1/00; B25G 1/01; B25G 1/102; B25D 2250/221

(57) ABSTRACT

A multifunctional smart hand tool integrates traditional hammer functionality with electronic sensor systems for measuring angle, distance, temperature, and humidity. The device further incorporates a microcontroller-based control system, an OLED display for real-time data visualization, and a power-assisted screwdriver driven by a compact DC gear motor. The tool includes user-operated switches to control motor direction and system power. Sensor data is collected via embedded modules and displayed to assist users in measurement tasks during operation. Designed for handymen, technicians, and field engineers, the invention combines multiple essential tools into a single compact, shock-resistant, and portable unit to improve efficiency, reduce tool loadout, and enable smart diagnostics in real-world conditions.

The invention relates to a multifunctional smart hammer tool integrating measurement sensors and an electric-powered adapter for driving screws and drill bits. The system includes a replaceable hammer head with a threaded connection and O-ring seal for impact resistance. An internal control system, featuring a microcontroller, displays real-time temperature, angle, and distance readings on an OLED display. A built-in lithium battery powers the sensors and motor, with charge management via an integrated charging module. External user controls include a main power button and forward/reverse limit switches for motor control. The bottom shaft accommodates an interchangeable adapter for multiple bit types, such as Phillips, flathead, and drill bits, allowing the device to function as a hammer, screwdriver, or drill. The invention offers a compact, shock-resistant, and rechargeable multi-tool suitable for varied environments.

A multifunctional smart hand tool integrates traditional hammer functionality with electronic sensor systems for measuring angle, distance, temperature, and humidity. The device further incorporates a microcontroller-based control system, an OLED display for real-time data visualization, and a power-assisted screwdriver driven by a compact DC gear motor. The tool includes user-operated switches to control motor direction and system power. Sensor data is collected via embedded modules and displayed to assist users in measurement tasks during operation. Designed for handymen, technicians, and field engineers, the invention combines multiple essential tools into a single compact, shock-resistant, and portable unit to improve efficiency, reduce tool loadout, and enable smart diagnostics in real-world conditions.

### BRIEF DESCRIPTION OF THE DRAWINGS

FIG. 1 is a top view of the smart hammer illustrating the outer housing and key sensor placements.

FIG. 1: Top view of the smart hammer showing the outer housing (100), OLED display (101), and various sensor openings including the laser distance sensor (112), temperature sensor (114), and the sensor module (113). Also shows the mounting for the DC gear motor (108).

FIG. 2 is a front view showing the display, buttons, and grip area.

FIG. 2: Front view showing the OLED display (101), main power button (102), forward (103) and reverse (104) microswitch controls, and visible portion of the USB Type-C Charging Port (115).

FIG. 3 is a detailed side view of internal electronic and sensor modules.

FIG. 3: Side cross-sectional view showing internal layout including the battery compartment (106) with power cells, shock-absorbing enclosure (106) surrounding the DC gear motor (108), and sensor assembly (113) including MPU6050 and DHT22 modules. Wiring path (116) is also illustrated.

FIG. 4 is a back view showing mounting features and battery housing.

FIG. 4: Back view depicting the removable lid (118) covering the battery compartment (106), USB Type-C Charging Port (115), and rear structural elements of the main housing (100).

FIG. 5 is a component view illustrating the swappable hammer head and threaded interface.

FIG. 5: Exploded view showing the threaded connection interface (110) between the hammer head (109) and the main housing (100), as well as the O-Ring seal (111) for shock absorption and protection.

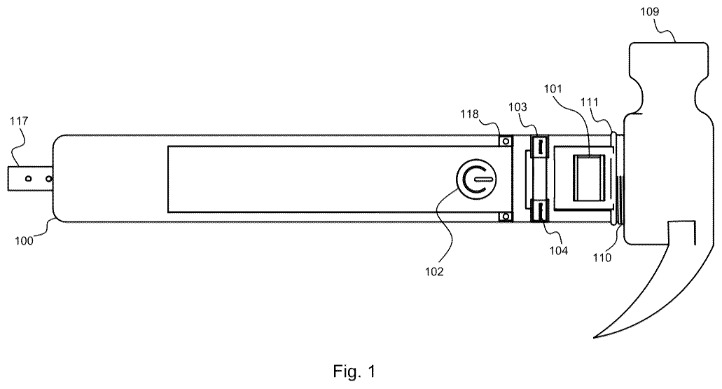

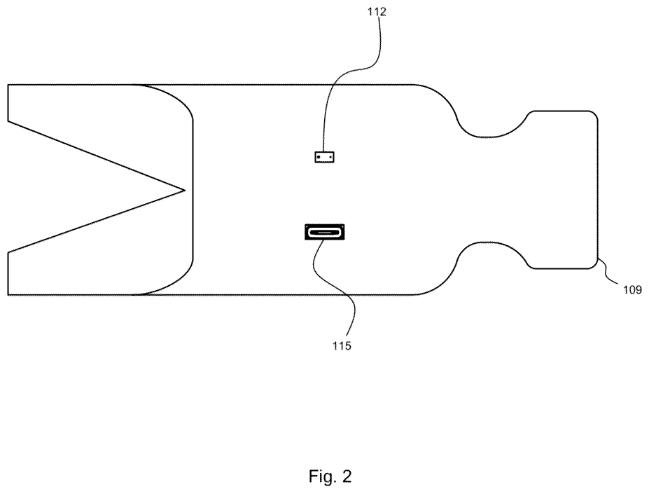

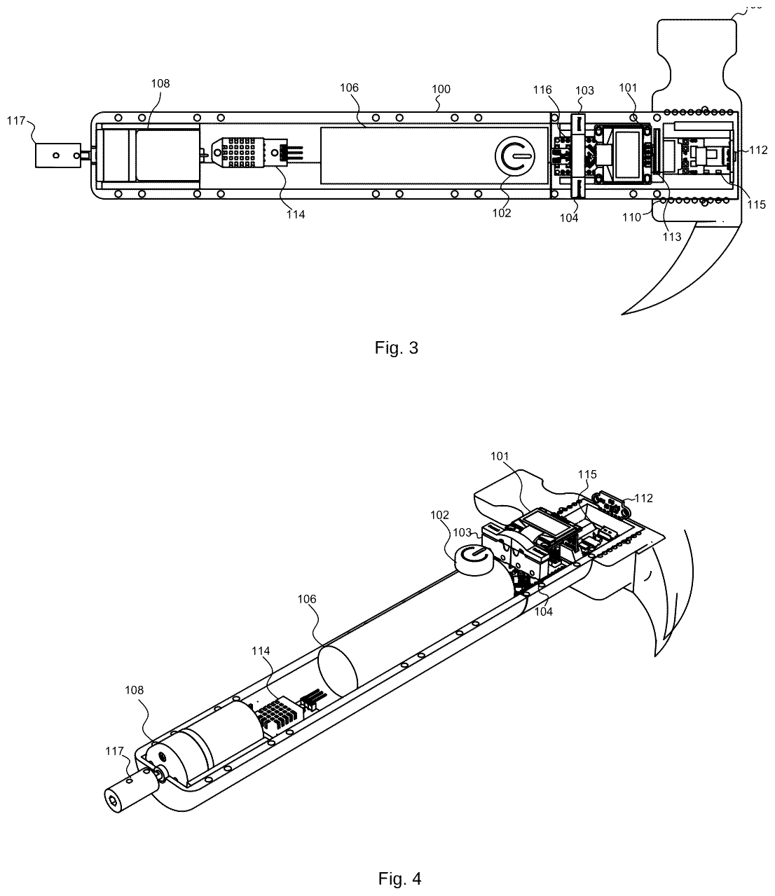

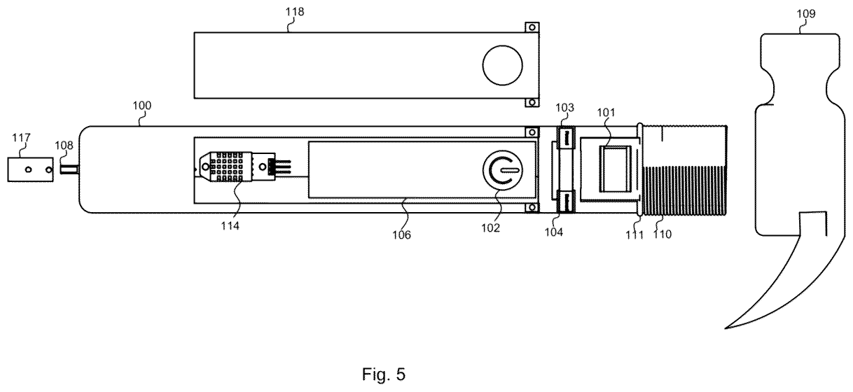

### STATEMENT REGARDING SUBSTITUTE SPECIFICATION

The applicant confirms that this substitute specification contains no new matter and is fully consistent with the original disclosure.

1. A multifunctional smart tool comprising:
A manually operated impact head removably secured to the tool body by a threaded connection, said connection optionally including sealing and shock-absorbing material for vibration dampening and impact resistance;
A handle constructed from materials selected from the group consisting of metal, wood, polymer composites, shock-absorbing materials, or combinations thereof, configured to provide structural integrity and impact resistance;
An internal electronic control system configured to process sensor inputs and control power-driven tool functions, said system comprising:
At least one angle measurement sensor configured to detect orientation and tilt of the tool;
At least one environmental sensor configured to detect ambient temperature and/or humidity;
At least one range-finding sensor configured to measure distance to an external target;
A user interface including:
A main control button configured to activate and deactivate all electronic systems of the tool;
At least two directional control switches configured to operate an integrated motor in forward and reverse modes;
A power-driven system including:
A rechargeable power source enclosed within a shock-resistant housing;
An integrated charging module configured to recharge the power source;
An integrated display configured to provide real-time output of sensor data including tool angle, ambient conditions, and distance readings;
A rotating output shaft coupled to the power-driven system and configured to receive interchangeable adapter fittings for multiple functional attachments including screwdriver bits and drill bits;
An internal mechanical structure with shock-absorbing materials and tightly packed components to prevent damage from mechanical impact during tool operation.

2. The tool of claim 1, wherein the sensors are selected from a group comprising: inertial measurement units (IMUs), thermistors, humidity sensors, time-of-flight sensors, laser sensors, infrared sensors, or equivalents thereof.

3. The tool of claim 1, wherein the control system is configured to support alternative microcontrollers or processing units functionally equivalent to an Arduino Nano.

4. The tool of claim 1, wherein the adapter fitting is configured to accept multiple bit types including but not limited to Phillips, flathead, hex, Torx, or drill bits.

5. The tool of claim 1, further comprising environmental protection elements including sealing gaskets, vibration dampening pads, and shock-absorbing fillers within the internal housing.

6. The tool of claim 1, wherein the internal components are mounted in a compact arrangement to optimize space utilization and mechanical durability.

7. The tool of claim 1, wherein the user interface is configured to display operational status of the motor and battery charge level on the integrated display.

8. The tool of claim 1, wherein any component described may be replaced by functionally equivalent alternatives without departing from the scope of the invention.

9. The tool of claim 1, wherein the handle is formed from one or more of the following materials: metal, wood, plastic, polymer composites, shock-absorbing elastomers, or a combination thereof to enhance structural durability and user ergonomics.

10. The tool of claim 1, wherein the angle measurement sensor comprises an MPU6050 gyroscopic sensor.

11. The tool of claim 1, wherein the environmental sensor comprises a DHT22 temperature and humidity sensor.

12. The tool of claim 1, wherein the range-finding sensor comprises a VL53L0X time-of-flight (ToF) laser sensor.
